(19) United States
(12) Patent Application Publication
(10) Pub. No.: US 2020/0089250 A1
(43) Pub. Date: Mar. 19, 2020

(54) METHOD AND APPARATUS FOR VEHICLE SUSPENSION SYSTEM CONDITION MONITORING

(71) Applicant: GM GLOBAL TECHNOLOGY OPERATIONS LLC, DETROIT, MI (US)

(72) Inventors: Robert P. Marble, White Lake, MI (US); Brian K. Saylor, South Lyon, MI (US); Xinyu Du, Oakland Township, MI (US); Mutasim A. Salman, Madison, WI (US)

(21) Appl. No.: 16/131,235

(22) Filed: Sep. 14, 2018

(51) Int. Cl. G05D 1/02; B60Q 9/00; G07C 5/08; G06K 9/00; G06T 7/73

(52) U.S. Cl. CPC G05D 1/0246; G05D 1/0257; B60Q 9/00; G05D 1/0276; G07C 5/0816; G06K 9/00791; G06T 2207/10004; G05D 2201/0213; G06T 2207/30252; G06T 2207/30181; G06T 2207/10028; G06T 2207/10044; G06T 7/74

(57) ABSTRACT

A system and method for determining and detecting a suspension system fault using visual sensor data. The system and method are operative to detect a horizon in response to an image using image processing techniques, compare the detected horizon to an expected or calculated horizon and to determine a faulty suspension component in response to a deviation of the detected horizon from the expected horizon.

### INTRODUCTION

The present invention generally relates to a system and method for estimating operational condition of a suspension system in a vehicle. More particular, the invention relates to a system and method for using a camera and a detected horizon for determining a relative condition of a vehicle suspension system in response to the detected horizon.

Autonomous vehicles are configured with numerous sensors to detect their environment and surroundings. This is important as the vehicle must navigation within this environment while avoiding all obstacles, maintaining optimal performance, and maintaining vehicle maintenance. An issue with vehicle operation is that autonomous vehicles may occasionally travel without passengers, with only cargo, or passengers in autonomous or non-autonomous vehicles, such as rental vehicles, may not have an interest in reporting maintenance issues. Thus, the vehicle may go through long periods of use without critical maintenance being performed.

In a vehicle suspension system dampers and other suspension components may degrade or fail suddenly and at different intervals and are considered a safety issue with regard to vehicle handling. However, the state of health of suspension components, including vehicle damper system components, is often not identified by the vehicle operator until the component has degraded to a point where the suspension component or other vehicle components may be damaged. It would be desirable to identify these component degradations in order to avoid these problems.

The above information disclosed in this background section is only for enhancement of understanding of the background of the invention and therefore it may contain information that does not form the prior art that is already known in this country to a person of ordinary skill in the art.

### SUMMARY OF THE INVENTION

Disclosed herein are vehicle control methods and systems and related control logic for detecting and controlling vehicle systems, methods for making and methods for operating such systems, and motor vehicles equipped with onboard control systems. By way of example, and not limitation, there is presented various embodiments of a vehicle suspension system, and a method for detecting a potential failure condition and identifying a vehicle component failure in response to the detection are disclosed herein.

In accordance with an aspect of the present invention, a vehicle control system is disclosed comprising a visual sensor for detecting an image depicting a detected horizon, a memory for storing a reference horizon, a processor for comparing the detected horizon and the reference horizon, the processor further operative to generate a control signal in response to the detected horizon deviating from the reference horizon, and a vehicle controller for controlling a vehicle control system in response to the control signal.

In accordance with another aspect of the present invention, a method for controlling a vehicle comprising receiving an image data, determining a detected horizon in response to the image data, generating a control signal in response to a deviation between the detected horizon and a reference horizon, and controlling a vehicle in response to the control signal.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing an automotive vehicle according to an exemplary embodiment for implementing the present invention.

FIG. 2 shows an exemplary vehicle suspension system according to an exemplary embodiment of the present invention.

FIG. 3 shows an exemplary a suspension monitoring system for implementing the method and system according to the present invention.

FIG. 4 shows an exemplary environment for implementing the method and system according to the present invention.

FIGS. 5a, 5b, 5c, 5d, and 5e show a series of fields of view for an exemplary camera according to the exemplary method and system for vehicle suspension system condition monitoring.

FIG. 6 shows an exemplary block diagram of a system for vehicle suspension system condition monitoring according to an exemplary embodiment of the present invention.

FIG. 7 is a flow diagram of a method for vehicle suspension system condition monitoring according to an exemplary embodiment of the present invention.

The above advantage and other advantages and features of the present disclosure will be apparent from the following detailed description of the preferred embodiments when taken in connection with the accompanying drawings.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above and below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

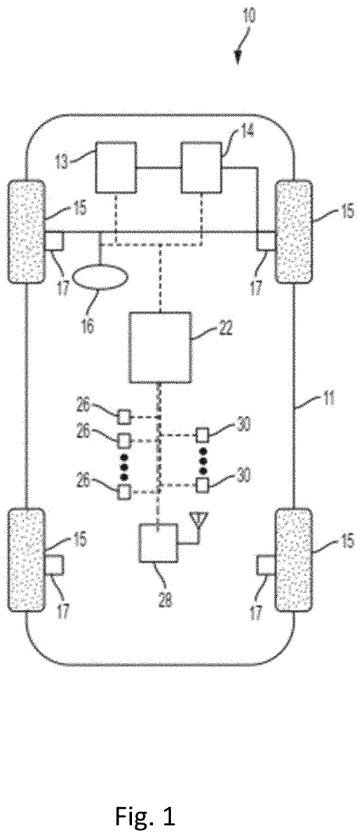

FIG. 1 schematically illustrates an automotive vehicle 10 according to the present disclosure. The vehicle 10 generally includes a body 11 and wheels or tires 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used. In some embodiments, the vehicle 10 is an autonomous or semi-autonomous vehicle. In some embodiments, the vehicle 10 is operated directly by a vehicle operator.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 16. While depicted as including a steering wheel and steering column for illustrative purposes, in some embodiments, the steering system 16 may not include a steering wheel. The vehicle 10 additionally includes one or more suspension system components, such as vehicle dampers or shock absorbers 17. In some embodiments, as shown in FIG. 1, a vehicle damper 17 is positioned adjacent to each of the wheels 15.

In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver. In some embodiments, the navigation system 28 provides data to the controller 22 to assist with autonomous or semi-autonomous operation of the vehicle 10.

With further reference to FIG. 1, the vehicle 10 also includes a plurality of sensors 26 configured to measure and capture data on one or more vehicle characteristics, including but not limited to vehicle speed, tire pressure and/or acceleration (including vertical acceleration), noise or sound, vertical displacement, and vehicle acceleration. In the illustrated embodiment, the sensors 26 include, but are not limited to, an accelerometer, a speed sensor, a tire pressure/acceleration monitoring sensor, a displacement sensor (such as, for example and without limitation, a lower control arm displacement sensor), an acceleration sensor (such as, for example and without limitation, a lower control arm acceleration sensor and/or an upper mount acceleration sensor), an active noise cancellation (ANC) microphone, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

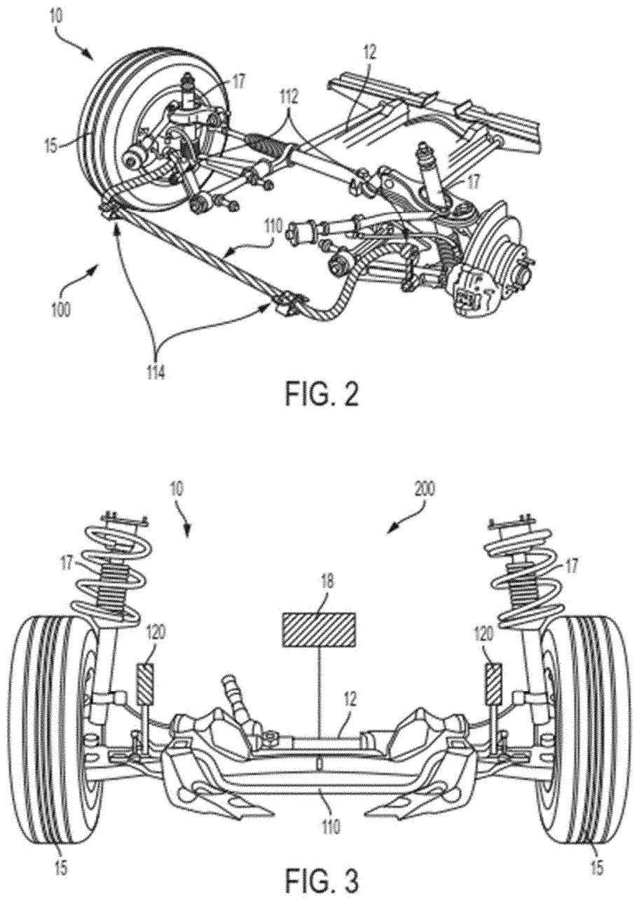

The vehicle, such as the vehicle 10 partially shown in FIG. 2, includes a chassis 12, an axle 13, and at least one wheel 15. One or more suspension components may form a suspension system 100 coupled to the chassis 12 and/or the axle 13 near the wheels 15. The suspension system 100 includes, in some embodiments, one or more dampers 17 configured to dampen the effect of road-induced vibrations, such as those caused by irregular road surfaces, etc. The suspension system 100 also includes, in some embodiments, one or more stabilizer system components including a stabilizer or sway bar 110, one or more sway bar links 112, and one or more sway bar bushings 114. Throughout this disclosure, the terms “stabilizer” and “sway” are used interchangeably. The sway bar 110 helps to reduce the body roll of the vehicle 10 during fast cornering or over road irregularities. The sway bar 110 connects opposite (left/right) wheels 16 together through short lever arms linked by a torsion spring. The sway bar 110 increases the roll stiffness of the suspension system 100, that is, its resistance to roll in turns, independent of its spring rate in the vertical direction. Failure or wear in any of the suspension system components, including but not limited to the vehicle dampers 17, the sway bar 110, the sway bar links 112, and the sway bar bushings 114, can lead to issues with vehicle stability, as well as increased vehicle noise.

As shown in FIG. 3, the vehicle 10 includes a suspension monitoring system 200. In some embodiments, the system 200 includes one or more sensors 120. The sensors 120 include, for example and without limitation, lower control arm displacement or acceleration sensors and upper mount acceleration sensors. The sensors 120 measure a displacement and/or acceleration of one or more of the components of the suspension system 100 of the vehicle 10. The sensors 120 are electronically connected to a vehicle controller, such as the controller 22, as discussed in greater detail herein. In some embodiments, the vehicle corner displacements and/or body roll is determined from data received from other vehicle sensors/accelerometers.

Additionally or alternatively, in some embodiments, the suspension monitoring system 200 of the vehicle 10 includes an inertial measurement unit (IMU) 18. The IMU 18 is coupled to the chassis 12. The IMU 18 is an electronic device that measures and reports the dynamically changing movements of the vehicle using a combination of accelerometers and gyroscopes. The IMU 18 provides a stream of data related to the linear acceleration of the vehicle on three principal axes, together with the three sets of rotation parameters (pitch, role, and heading) to a vehicle controller, such as the controller 22, as discussed in greater detail herein. In some embodiments, a safety data module (not shown) coupled to the vehicle 10 also includes sensors capable of measuring the lateral acceleration of the vehicle 10. The safety data module is also electronically connected to the vehicle controller to transmit sensor data for further analysis and calculation, as discussed in greater detail herein.

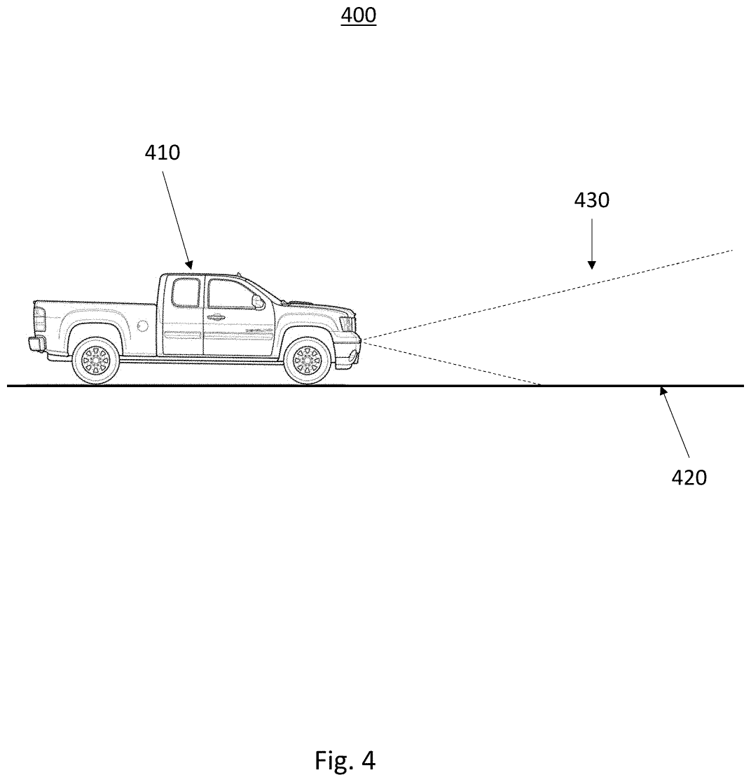

Turning now to FIG. 4 an exemplary system 400 for implementing the method and system for vehicle suspension system condition monitoring is shown. In this exemplary embodiment a vehicle 410 is equipped with a sensor, such as a camera, wherein the camera has a field of view (FOV) 430. The vehicle, equipped with a previously described suspension system rides on a road surface 420. The FOV is configured such that under certain conditions, such as a flat road surface, the horizon is visible within the FOV. A flat road condition may be determined from map data stored in a memory, a global positioning system coordinate and velocity data identified by a remote host or service indicative of a known flat road surface, or data stored in response to previously experienced travel conditions. Alternatively, LIDAR, RADAR or other visual sensors to define relative condition of suspension springs.

In this exemplary embodiment, the system and method are operative to use the average or reference horizon as a correlation plane. Differences in the reference horizon and the visible horizon in the FOV may indicate suspension issues. Differences may be plotted to contrast the vehicle plane to look for any corner that would have a change in perspective. Alternately, using on board sensors, such as wheel position, IMU or acceleration, may help identify a change in frequencies in the chassis and suspension system.

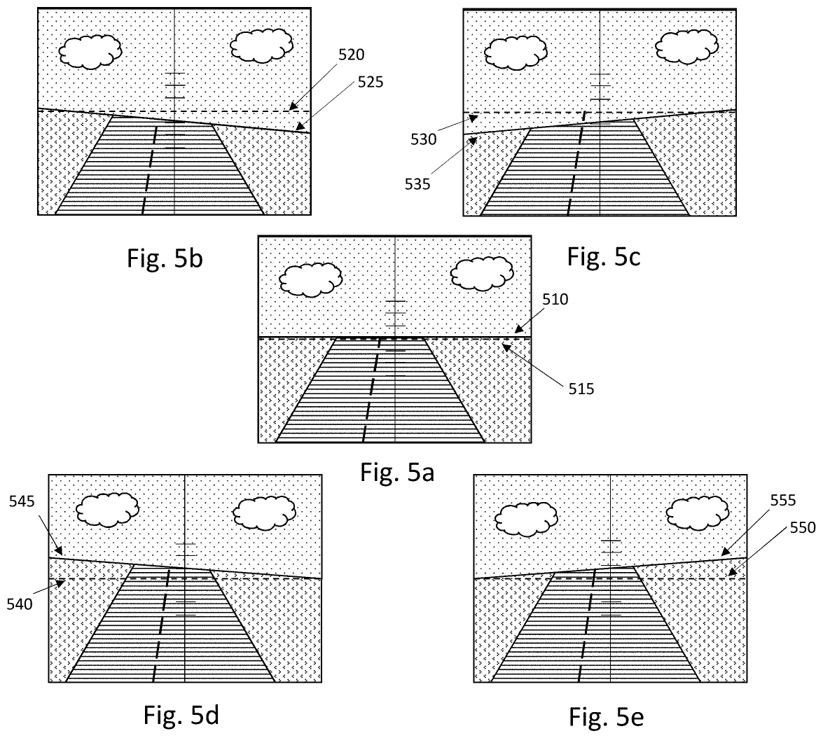

Turning now to FIG. 5a to FIG. 5e, a series of fields of view for an exemplary camera according to the exemplary method and system for vehicle suspension system condition monitoring are shown. FIG. 5a is illustrative of an exemplary field of view wherein the suspension components are estimated to not have a detect and the normal calculated horizon 515 is shown. The calculated horizon 515 is depicted as a dashed line in FIG. 5a and the detected horizon 510 within the field of view is shown as a solid line. In the instance where no faults have occurred, the detected horizon 510 and the calculated horizon 515 have a corresponding roll angle of zero degrees and a pitch angle of zero degrees.

Turning now to FIG. 5b, an exemplary field of view wherein the left front suspension component has a fault is shown. In the instance of a left front suspension fault, the left front corner of the vehicle will be lower than expected and therefore the average roll of the detected horizon 525 will have a magnitude greater than zero and the average pitch angle will be greater than zero. Therefore, in this exemplary embodiment, the detected horizon 525 will appear to be lower than the calculated horizon 520 and pitch to the left.

Turning now to FIG. 5c, an exemplary field of view wherein the right front suspension component has a fault is shown. In the instance of a right front suspension fault, the right front corner of the vehicle will be lower than expected and therefore the average roll of the detected horizon 535 will have a magnitude greater than zero and the average pitch angle will be greater than zero. Therefore, in this exemplary embodiment, the detected horizon 535 will appear to be lower than the calculated horizon 520 and pitch to the right.

Turning now to FIG. 5d, an exemplary field of view wherein the left rear suspension component has a fault is shown. In the instance of a left rear suspension fault, the left rear corner of the vehicle will be lower than expected and therefore the average roll of the detected horizon 545 will have a magnitude greater than zero and the average pitch angle will be less than zero. Therefore, in this exemplary embodiment, the detected horizon 545 will appear to be higher than the calculated horizon 540 and pitch to the left.

Turning now to FIG. 5e, an exemplary field of view wherein the right rear suspension component has a fault is shown. In the instance of a right rear suspension fault, the right rear corner of the vehicle will be lower than expected and therefore the average roll of the detected horizon 555 will have a magnitude greater than zero and the average pitch angle will be less than zero. Therefore, in this exemplary embodiment, the detected horizon 555 will appear to be higher than the calculated horizon 550 and pitch to the right.

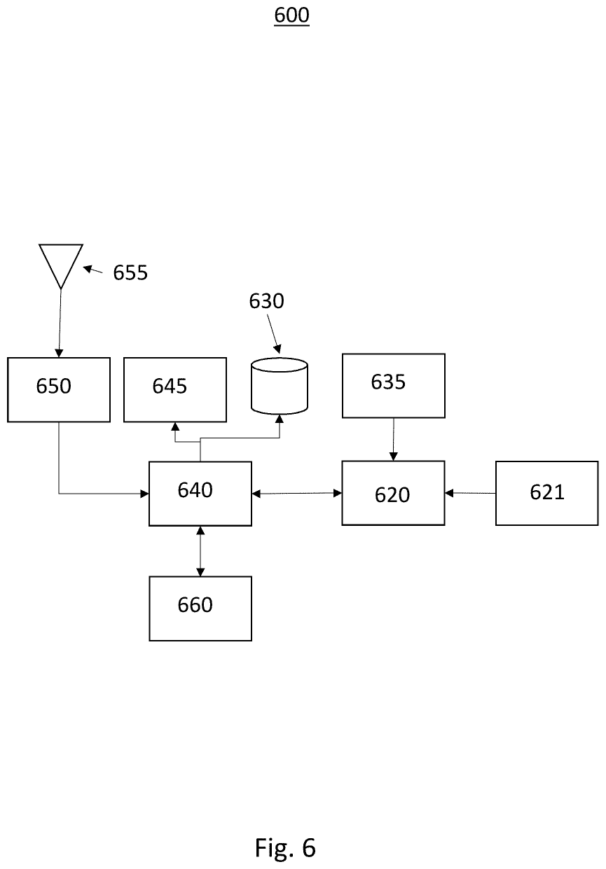

Turning now to FIG. 6, a block diagram 600 illustrating an exemplary system for vehicle suspension system condition monitoring 600 according to an exemplary embodiment is shown. The exemplary system has a body mounted camera 621 with a forward field of view. While the camera 62.1 has an exemplary field of view in the forward direction, a camera or visual sensor with any field of view may be used for the present application. Visual sensors may include Cameras, infrared cameras, LIDAR, RADAR, and others. The camera 621 is operative to couple images or image data to an image processor 620.

The image processor 620 is operative to receive the image data and process the image to determine a detected horizon. The image processor is then operative to define a reference horizon in response to a sensor data from a sensor 635. The sensor 635 may be a GPS sensor, an accelerometer, gyroscope, magnometer, or the like. IMU, Z Accel, Wheel Position Sensors and Corner accelerometers existing in functional safety and adaptive suspension systems and may be used to determine a reference horizon by examining frequency shifts of these onboard suspension sensors. The reference horizon may be determined in response to a plurality of data from a number of sensors. The image processor is then operative to compare the reference horizon to the detected horizon in order to determine vehicle attitude changes looking for faults in corner, such as broken or damaged springs etc. The image processor 620 may further be operative to use reference data from signature road surface, or average data for horizon in regular use as a contrast measure for changes in vehicle attitude.

Alternatively, the image processor 620 may be operative to receive cloud based data from reference horizon and other vehicles to create a contrast window for proper vehicle attitude. The cloud based data and/or GPS data may be received wirelessly through an antenna 655 and a radio frequency (RF) processor 650. The data may be first processed by vehicle processor 640 and stored in a memory 630.

In an exemplary embodiment, the image processor 620 may determine that the reference horizon and the detected horizon do not correlate and that a suspension failure may have occurred. The image processor may then determine a relative position of the detected horizon compared to the reference horizon and determined the suspension element that most likely is faulty. Alternatively, the image processor 620 may couple data related to a comparison of the detected horizon and the reference horizon and couple this data to the vehicle processor 640. The vehicle processor 640 may then be operative to determine the faulty suspension component in response to the data and generate a control signal indicative of the fault to couple to the vehicle controller 660. The vehicle controller 660 may then be operative to control the vehicle in a manner that compensates for the faulty suspension component, such as lower velocity, slower cornering, etc. In addition, the vehicle processor 640 may couple an error signal to a user interface 645 to indicate to a driver, passenger, or remote server that a faulty component exists.

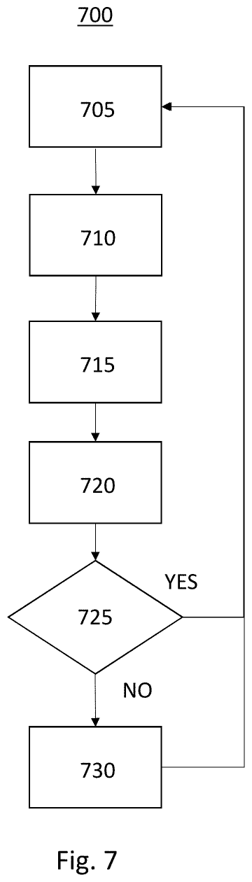

Turning now to FIG. 7, a flow diagram of the method of one embodiment for vehicle suspension system condition monitoring 700 is shown. In this exemplary embodiment, the method is first operative to receive an image data from a camera or visual sensor 705. The method is then operative to detect a horizon using image processing techniques, or the like, in response to the image data to generate a detected horizon 710. The method is then operative to receive a sensor data from a vehicle sensor or remote sensor 715. The method then calculates a reference horizon in response to the sensor data 720. Alternatively, the reference horizon may be determined in response to an expected horizon location when all vehicle components are functioning as intended. This reference horizon, or data related to the reference horizon may be stored in memory and retrieved by the method. The method is then operative to compare the reference horizon to the detected horizon 725. If the reference horizon and the detected horizon correlate, then no fault is expected and the method is operative to return to wait tbr the next image data 705. If the reference horizon and detected horizon do not correlate, the method is operative to generate a control signal indicative of the fault and couple this control signal to the vehicle processor 730. The method is then operative to return to wait for the next image data 705. Alternatively, the method may be operative to set a counter and generate the control signal indicative of a fault in response to a plurality of consecutive imaged indicative of a fault.

It should be emphasized that many variations and modifications may be made to the herein-described embodiments, the elements of Which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should he apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about t to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle control system comprising:
a visual sensor for detecting an image depicting a detected horizon;
a memory for storing a reference horizon;
a processor for comparing the detected horizon and the reference horizon, the processor further operative to generate a control signal in response to the detected horizon deviating from the reference horizon; and
a vehicle controller for controlling a vehicle control system in response to the control signal.

2. The vehicle control system of claim 1 wherein the detected horizon and the reference horizon deviate in at least one of roll angle and pitch angle.

3. The vehicle control system of claim 1 wherein the controller is part of an autonomous vehicle control system.

4. The vehicle control system of claim 1 wherein the visual sensor is a camera.

5. The vehicle control system of claim 1 wherein the visual sensor is a radar receiver.

6. The vehicle control system of claim 1 wherein the visual sensor is a lidar detector.

7. The vehicle control system of claim 1 wherein the reference horizon is determined in response to a sensor data received from a vehicle sensor.

8. The vehicle control system of claim 1 wherein the processor is further operative to determine the detected horizon in response to the image.

9. The vehicle control system of claim 1 wherein the vehicle controller is further operative to generate a user interface warning signal.

10. The vehicle control system of claim 1 wherein the control signal is indicative of a failure of a suspension element.

11. A method for controlling a vehicle comprising:
receiving an image data;
determining a detected horizon in response to the image data;
generating a control signal in response to a deviation between the detected horizon and a reference horizon; and
controlling a vehicle in response to the control signal.

12. The method of claim 11 wherein the detected horizon and the reference horizon deviate in at least one of roll angle and pitch angle.

13. The method of claim 11 wherein the controlling the vehicle comprises compensating for a faulty suspension component.

14. The method of claim 11 wherein the image data is received from a camera.

15. The method of claim 11 wherein the image data is received from a radar receiver.

16. The method of claim 11 wherein the image data is received from a lidar detector.

17. The method of claim 11 wherein the reference horizon is determined in response to a sensor data received from a vehicle sensor.

18. The method of claim 11 wherein the reference horizon is determined in response to a reference data received via a wireless network.

19. The method of claim 11 further comprising generating a user interface warning signal indicative of a suspension failure in response to the control signal.

20. The method of claim 11 wherein the control signal is indicative of a failure of a suspension element.
